(19) United States
(12) Patent Application Publication
(10) Pub. No.: US 2008/0117236 A1
(43) Pub. Date: May 22, 2008

(54) Liquid crystal display with RGB gray-scale voltage controller

(75) Inventor: Xiao-Jing Qi, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/986,381

(22) Filed: Nov. 21, 2007

(30) Foreign Application Priority Data
Nov. 21, 2006 (TW) 95142994

(51) Int. Cl. G09G 5/10

(52) U.S. Cl. 345/690

(57) ABSTRACT

An exemplary liquid crystal display (300) includes a display panel (380), a gate driving circuit (310) configured for applying a plurality of gate signals to the display panel, and a data driving circuit (320) configured for applying a plurality of red, green and blue gray-scale voltages to the display panel when the gate signals are applied to the display panel. The data driving circuit includes a controller (360). The controller is capable of adjusting the red, green and blue gray-scale voltages respectively according to user signal.

### FIELD OF THE INVENTION

The present invention relates to liquid crystal displays (LCDs), and more particularly to an LCD having a controller that can reduce a color shift phenomenon.

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions. Because liquid crystal of an LCD is not self-luminous, an LCD usually needs a backlight as a light source.

FIG. 2 is essentially an abbreviated circuit diagram of a typical LCD 100. The LCD 100 includes a display panel 130, a data driving circuit 120, a gate driving circuit 110, and a backlight (not shown). The display panel 130 includes a first substrate (not shown), a second substrate (not shown) arranged parallel to the first substrate, and a liquid crystal layer (not shown) sandwiched between the first substrate and the second substrate.

The first substrate includes a number n (where n is a natural number) of gate lines 111 that are parallel to each other and that each extend along a first direction, and a number m (where m is also a natural number) of data lines 121 that are parallel to each other and that each extend along a second direction orthogonal to the first direction. The first substrate also includes a plurality of thin film transistors (TFTs) 101 that function as switching elements. The first substrate further includes a plurality of pixel electrodes 102 formed on a surface thereof facing toward the second substrate. Each TFT 101 is provided in the vicinity of a respective point of intersection of the gate lines 111 and the data lines 121.

Each TFT 106 includes a gate electrode, a source electrode, and a drain electrode. The gate electrode of each TFT 101 is connected to the corresponding gate line 101. The source electrode of each TFT 101 is connected to the corresponding data line 121. The drain electrode of each TFT 101 is connected to a corresponding pixel electrode 102.

The second substrate includes a plurality of common electrodes 103 opposite to the pixel electrodes 102. In particular, the common electrodes 103 are formed on a surface of the second substrate nearest to the first substrate, and are made from a transparent material such as ITO (Indium-Tin Oxide) or the like. A pixel electrode 102, a common electrode 103 facing toward the pixel electrode 102, and liquid crystal molecules of the liquid crystal layer sandwiched between the two electrodes 102, 103 cooperatively define a single pixel unit.

Generally, each pixel unit corresponds to a color filter (not shown) positioned at the surface of the second substrate nearest to the first substrate. The color filter includes red, green and blue (RGB) color resins. The backlight emits white light beams. The RGB color resins filter white light beams passing therethrough, thus producing respective RGB color light beams. That is, the light beams through each pixel unit are monochrome red, green or blue color light beams.

When the LCD 100 displays an image, the gate driving circuit 110 outputs a plurality of gate signals to the gate lines 111 in sequence. The data driving circuit 120 applies a plurality of gray-scale voltages to the data lines 121. The common electrodes 103 have a predetemmined common voltage applied thereto. When a gate signal is applied to a gate electrode of the TFT 101, the TFT 101 is activated. A gray-scale voltage is applied to the corresponding pixel electrode 102 via the source electrode and drain electrode of the TFT 101. Thus, an electric field is generated between the pixel electrode 102 and the corresponding common electrode 103. A voltage of the electric field is defined as a driving voltage. The liquid crystal molecules in the electric field are driven to twist a certain angle according to an intensity of the electric field. Therefore, the RGB color light beams have a corresponding transmittance.

The white light beams have a different transmission-voltage (T-V) curve relative to the RGB color light beams. FIG. 3 shows T-V curves of the white light beams and the RGB light beams. The T-V curves 202, 204, 206, 208 respectively correspond to the white light beams, the red color light beams, the green color light beams, and the blue color light beams. As for a same gray-scale voltage V₀, transmissions of the RGB color light beams and the white light beams are clearly different.

However, the LCD 100 uses a same gray-scale voltage without considering unique optical characteristics of the different color (RGB) light beams. It is assumed that the optical characteristics of the RGB color light beams are the same as the white light beams. As a result, the LCD 100 may have display problems such as a color shift (which causes unwanted colors) or abnormal color temperature.

What is needed, therefore, is an LCD that can overcome the above-described deficiencies.

### SUMMARY

In one preferred embodiment, a liquid crystal display includes a display panel, a gate driving circuit configured for applying a plurality of gate signals to the display panel, and a data driving circuit configured for applying a plurality of red, green and blue gray-scale voltages to the display panel when the gate signals are applied to the display panel. The data driving circuit includes a controller. The controller is capable of adjusting the red, green and blue gray-scale voltages respectively according to user signal.

Other novel features and advantages will become more apparent from the following detailed description when taken in conjunction with the accompanying drawings.

### BRIEF DESCRIPTION OF THE DRAWINGS

FIG. 1 is essentially an abbreviated circuit diagram of a liquid crystal display according to an exemplary embodiment of the present invention.

FIG. 2 is essentially an abbreviated circuit diagram of a conventional liquid crystal display.

FIG. 3 is a transmission-voltage graph relating to the liquid crystal display of FIG. 2, showing transmission curves of white light beams and R, G, B light beams.

### DETAILED DESCRIPTION OF PREFERRED EMBODIMENTS

Reference will now be made to the drawings to describe preferred and exemplary embodiments of the present invention in detail.

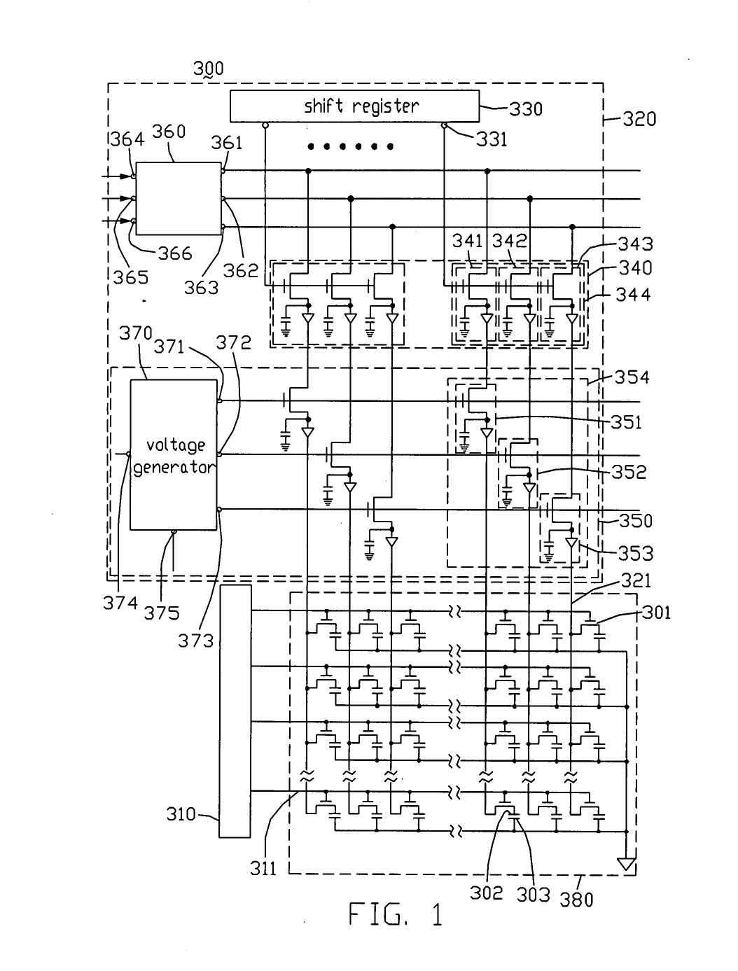

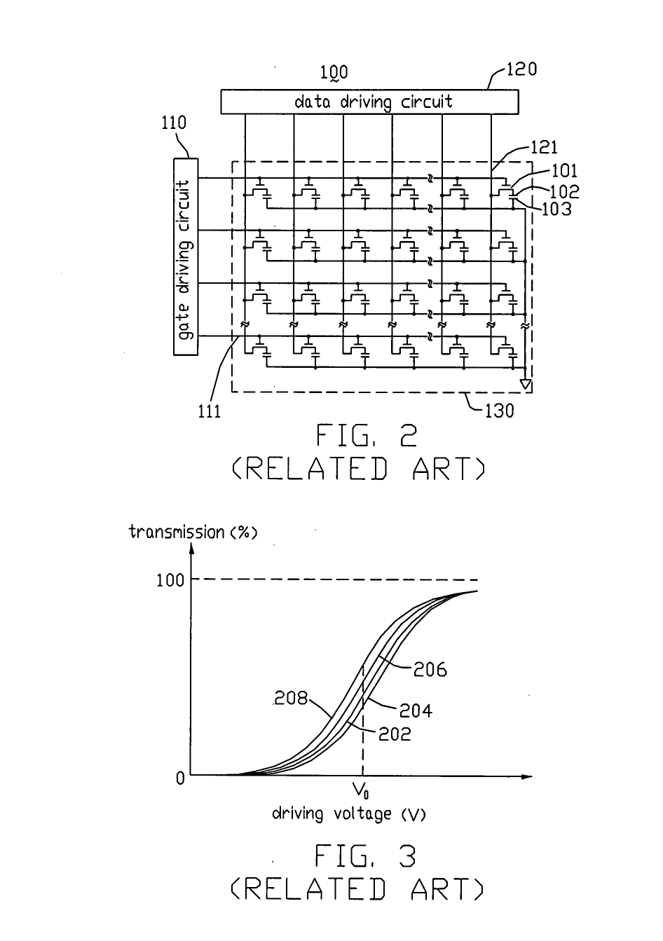

Referring to FIG. 1, an LCD 300 according to an exemplary embodiment of the present invention is shown. The LCD 300 includes a display panel 380, a data driving circuit 320, a gate driving circuit 310 and a backlight (not shown). The display panel 380 includes a first substrate (not shown), a second substrate (not shown) arranged parallel to the first substrate, and a liquid crystal layer (not shown) sandwiched between the first substrate and the second substrate.

The first substrate includes a number n (where n is a natural number) of gate lines 311 that are parallel to each other and that each extend along a first direction, and a number m (where m is also a natural number) of data lines 321 that are parallel to each other and that each extend along a second direction orthogonal to the first direction. The first substrate also includes a plurality of thin film transistors (TFTs) 301 that function as switching elements. The first substrate further includes a plurality of pixel electrodes 303 formed on a surface thereof facing toward the second substrate. Each TFT 301 is provided in the vicinity of a respective point of intersection of the gate lines 311 and the data lines 321.

Each TFT 306 includes a gate electrode, a source electrode, and a drain electrode. The gate electrode of each TFT 301 is connected to the corresponding gate line 301. The source electrode of each TFT 301 is connected to the corresponding data line 321. The drain electrode of each TFT 301 is connected to a corresponding pixel electrode 302.

The second substrate includes a plurality of common electrodes 303 generally opposite to the pixel electrodes 303. In particular, the common electrodes 303 are formed on a surface of the second substrate nearest to the first substrate, and are made from a transparent material such as ITO (Indium-Tin Oxide) or the like. A pixel electrode 302, a common electrode 303 facing toward the pixel electrode 303, and liquid crystal molecules of the liquid crystal layer sandwiched between the two electrodes 302, 303 cooperatively define a single pixel unit.

The data driving circuit 320 includes a shift register 330, a sampler 340, a controller 350, and a digital-to-analog converter (DAC) 360. The DAC 360 converts digital signals to analog signals. The sampler 340 is configured to sample gray-scale voltages. The controller 350 is capable of storing the gray-scale voltages sampled by the sampler 340, and outputting the voltages to the display panel 380. In this embodiment, the digital signals include red, green and blue digital signals, and the analog signals include red, green and blue gray-scale voltages. The DAC 360 is configured to convert the red, green and blue digital signals into red, green and blue gray-scale voltages respectively.

The DAC 360 includes a red signal input 364, a green signal input 365, a blue signal input 266, a red signal output 361, a green signal output 362, and a blue signal output 363. The red, green and blue signal inputs 364, 365, 366 are capable of receiving the red, green and blue digital signals respectively. The red, green and blue signal outputs 361, 362, 363 are capable of outputting the red, green and blue gray-scale voltages respectively to the sampler 340.

The shift register 330 includes a plurality of sampling-control terminals 331. The sampler 340 includes a plurality of sampling unit groups 344. Each of the sampling unit groups 344 includes a red sampling unit group 341, a green sampling unit group 342, and a blue sampling unit group 343. The red, green and blue sampling unit groups 341, 342, 343 have the same circuitry configuration. Taking one red sampling unit group 341 as an example, the red sampling unit group 341 includes a first transistor (not labeled), a first diode (not labeled), and a first capacitor (not labeled). A positive pole of the first diode is connected to a drain electrode of the first transistor, and to ground via the first capacitor. Gate electrodes of the three first transistors of each sampling unit group 344 are connected to a corresponding sampling-control terminal 331.

The controller 350 includes a voltage generator 370 and a plurality of controlling unit groups 354. Each of the controlling unit groups 354 includes a red controlling unit group 351, a green controlling unit group 352, and a blue controlling unit group 353. The red, green and blue controlling unit groups 351, 352, 353 have the same circuitry configuration. Taking one red controlling unit group 351 as an example, the red controlling unit group 351 includes a second transistor (not labeled), a second diode (not labeled), and a second capacitor (not labeled). A positive pole of the second diode is connected to a drain electrode of the second transistor, and to ground via the second capacitor.

The voltage generator 370 includes an enable signal input 374, a controlling signal input 375, a red controlling output 371, a green controlling output 372, and a blue controlling output 373. The red controlling output 371 is connected to the gate electrodes of the second transistors of all the red controlling unit groups 351 of all the controlling unit groups 354. The green controlling output 372 is connected to the gate electrodes of the second transistors of all the green controlling unit groups 352 of all the controlling unit groups 354. The blue controlling output 373 is connected to the gate electrodes of the second transistors of all the blue controlling unit groups 353 of all the controlling unit groups 354.

The enable signal input 374 and the controlling signal input 375 are connected to an external circuit. When the enable signal input 374 receives an enable signal from the external circuit, the voltage generator 370 generates high-level voltages and provides the high-level voltages to the red, green, and blue controlling outputs 371, 372, 373.

The red signal output 361 is connected to corresponding data lines 321 via source electrodes and the drain electrodes of the first transistors of the red sampling unit groups 341, the positive poles and negative poles of the first diodes of the red sampling unit groups 341, source electrodes and the drain electrodes of the second transistors of the red controlling unit groups 351, and the positive poles and negative poles of the second diodes of the red controlling unit groups 351 in sequence.

The green signal output 362 is connected to corresponding data lines 321 via source electrodes and the drain electrodes of the first transistors of the green sampling unit groups 342, the positive poles and negative poles of the first diodes of the green sampling unit groups 342, source electrodes and the drain electrodes of the second transistors of the green controlling unit groups 352, and the positive poles and negative poles of the second diodes of the green controlling unit groups 352 in sequence.

The blue signal output 363 is connected to corresponding data lines 321 via source electrodes and the drain electrodes of the first transistors of the blue sampling unit groups 343, the positive poles and negative poles of the first diodes of the blue sampling unit groups 343, source electrodes and the drain electrodes of the second transistors of the blue controlling unit groups 353, and the positive poles and negative poles of the second diodes of the blue controlling unit groups 353 in sequence.

When the LCD 300 displays an image, the red, green and blue signal outputs 361, 362, 363 continuously output red, green and blue gray-scale voltages. The sampling-control terminals 331 apply a high-level voltage to the corresponding sampling unit groups 344, and the first transistors of the red, green and blue sampling unit groups 341, 342, 343 are in an on state.

The red, green and blue gray-scale voltages outputted from the red, green and blue signal outputs 361, 362, 363 are respectively stored in the corresponding first capacitors via the on-state first transistors.

The enable signal input 374 receives an enable signal from the external circuit, and the red, green and blue controlling outputs 371, 372, 373 output high-level voltages. Thus, the second transistors of the red, green and blue controlling unit groups 351, 352, 353 are in an on-state.

The red, green and blue (RGB) gray-scale voltages stored in the first capacitors are transferred to the corresponding second capacitors via the on-state second transistors respectively, and are stored in the corresponding second capacitors.

The gate driving circuit 310 applies a gate signal to a gate line 311. The gate signal turns on the corresponding TFTs 301 in sequence. The RGB gray-scale voltages stored in the second capacitors are applied to the corresponding pixel electrodes 302 via the data lines 321 and the on-state TFTs 301.

Therefore, in respect of each of the pixel units, an electric field is generated by a difference between the corresponding RGB gray-scale voltage of the pixel electrode 302 and the common voltage of the common electrode 303. A voltage of the electric field is defined as a driving voltage.

If the image displayed in the screen has a red color shift, a user can send a red color correction signal to the controlling signal input 375. In response to the red color correction signal, the high-level voltage outputted by the red controlling output 371 is lowered. The voltages of the gate electrodes of the second transistors are decreased. Because the second transistors are voltage-control elements, the current between the source electrode and the drain electrode is decreased in response to the drop in the voltage of the gate electrode. That is, the red gray-scale voltages are lowered. The intensities of the electric fields of the pixel units through which red light beams pass are decreased. Thus, the transmission of the red light beams is lowered, and the red color shift is reduced or eliminated.

For a green color shift or a blue color shift phenomenon, the modulation technique is similar to that described above in relation to red color shift. However, a green color shift is reduced or eliminated according to a green color correction signal, and a blue color shift is reduced or eliminated according to a blue color correction signal. The red, green and blue color correction signals can be preset in an external circuit according to user requirements or preferences.

In summary, the above-described exemplary LCD 300 has the controller 350, which can adjust the red, green and blue color gray-scale voltages respectively so as to correct red, green or blue color shift.

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of shape, size, and arrangement of parts within the principles of the present invention to the full extent indicated by the broad general meaning of the terms in which the appended claims are expressed.

What is claimed is:

1. A liquid crystal display comprising:
a display panel;
a gate driving circuit configured for applying a plurality of gate signals to the display panel; and
a data driving circuit configured for applying a plurality of red, green and blue gray-scale voltages to the display panel when the gate signals are applied to the display panel, the data driving circuit comprising a controller configured for adjusting selected of the red, green and blue gray-scale voltages respectively according to user instruction.

2. The liquid crystal display in claim 1, wherein the controller comprises a plurality of controlling unit groups, each of the controlling unit groups comprising a red controlling unit group, a green controlling unit group, and a blue controlling unit group, the red, green and blue controlling unit groups each comprising a first transistor, a first diode, and a first capacitor, the positive pole of the first diode being connected to a drain electrode of the first transistor and being connected to ground via the first capacitor.

3. The liquid crystal display in claim 2, wherein the controller further comprises a voltage generator, the voltage generator comprising a red controlling output connected to gate electrodes of the first transistors of the red controlling unit groups, a green controlling output connected to gate electrodes of the first transistors of the green controlling unit groups, and a blue controlling output connected to gate electrodes of the first transistors of the blue controlling unit groups.

4. The liquid crystal display in claim 3, wherein the voltage generator further comprises an enable signal input configured for receiving an enable signal, and a controlling signal input configured for adjusting voltages applied to selected of the red, green and blue controlling outputs according to the user instruction.

5. The liquid crystal display in claim 2, wherein the first transistors are voltage-control elements.

6. The liquid crystal display in claim 2, wherein the data driving circuit further comprises a shift register, a sampler, and a digital-to-analog converter, the sampler comprising a plurality of sampling unit groups configured for sampling the gray-scale voltages, the shift register comprising a plurality of sampling controlling terminals, the digital-to-analog converter comprising a red signal input, a green signal input, a blue signal input, a red signal output, a green signal output, and a blue signal output, the red, green and blue signal inputs being configured for respectively receiving red, green and blue digital signals from an external circuit, the red, green and blue signal outputs being configured for outputting the corresponding red, green and blue gray-scale voltages respectively.

7. The liquid crystal display in claim 6, wherein each of the sampling unit groups comprises a red sampling unit group, a green sampling unit group, and a blue sampling unit group; each of the red, green and blue sampling unit groups comprising a second transistor, a second diode, and a second capacitor, a positive pole of the second diode being connected to a drain electrode of the second transistor and being connected to ground via the second capacitor, gate electrodes of the three second transistors of each sampling unit group being connected to a corresponding sampling controlling terminal.

8. The liquid crystal display in claim 6, wherein each sampling unit group corresponds to one respective controlling unit group.

9. The liquid crystal display in claim 7, wherein the red signal output is connected to positive poles of the corresponding first diodes via the source electrodes and drain electrodes of the second transistors of the red sampling unit groups, the positive poles and the negative poles of the second diodes of the red sampling unit groups, and the source electrodes and drain electrodes of the first transistors of the red controlling unit groups in sequence.

10. The liquid crystal display in claim 7, further comprising a first substrate, a second substrate parallel to the first substrate, and a liquid crystal layer provided between the first substrate and the second substarte.

11. The liquid crystal display in claim 10, wherein the first substrate comprises a plurality of gate lines, a plurality of data lines intersecting the gate lines, a plurality of thin film transistors arranged at intersections of the gate lines and the data lines, and a plurality of pixel electrodes.

12. The liquid crystal display in claim 10, wherein the second substrate comprises a plurality of common electrodes generally opposite to the plurality of pixel electrodes respectively.

13. The liquid crystal display in claim 12, wherein a pixel electrode, a common electrode facing toward the pixel electrode, and liquid crystal molecules of the liquid crystal layer sandwiched between the common electrode and the pixel electrode cooperatively define a single pixel unit.

14. The liquid crystal display in claim 12, wherein each thin film transistor comprises a gate electrode connected to a corresponding gate line, a source electrode connected to a corresponding data line, and a drain electrode connected to a corresponding pixel electrode.

15. A liquid crystal display comprising:
a display panel;
a gate driving circuit configured for applying a plurality of gate signals to the display panel;
a data driving circuit configured for applying a plurality of red, green and blue gray-scale voltages to the display panel when the gate signals are applied to the display panel; and
a controller arranged in the data driving circuit, the controller being capable of adjusting selected of the red, green and blue gray-scale voltages respectively according to user instruction.

16. A liquid crystal display comprising:
a gate driving circuit;
a data driving circuit;
a display panel configured for displaying images under control of the gate driving circuit and the data circuit; and
a controller integrated in the data driving circuit, the controller configured for adjusting selected of red, green and blue color gray-scale voltages generated by the data driving circuit according to user instruction in order to negate color shift of images displayed by the display panel.

17. The liquid crystal display in claim 16, wherein the controller comprises a plurality of controlling unit groups, each of the controlling unit groups comprising a red controlling unit group, a green controlling unit group, and a blue controlling unit group, the red, green and blue controlling unit groups each comprising a transistor, a diode and a capacitor, the positive pole of the diode being connected to a drain electrode of the transistor and being connected to ground via the capacitor.

18. The liquid crystal display in claim 16, wherein the display panel comprises a plurality of gate lines connected to the gate driving circuit, a plurality of data lines intersecting with the gate lines and connected to the data driving circuit, and a plurality of thin film transistors arranged in a matrix, with each thin film transistor corresponding to a respective crossing of the gate lines and the data lines.
